(19) United States
(12) Patent Application Publication
(10) Pub. No.: US 2011/0128410 A1
(43) Pub. Date: Jun. 2, 2011

(54) Apparatus for and method of taking image of mobile terminal

(75) Inventors: Sung Koo Lee, Suwon-si (KR); Seung Hwan Lee, Yongin-si (KR)

(73) Assignee: SAMSUNG ELECTRONICS CO., LTD., Suwon-si (KR)

(21) Appl. No.: 12/927,994

(22) Filed: Dec. 1, 2010

(30) Foreign Application Priority Data
Dec. 1, 2009 (KR) 10-2009-0117591

(51) Int. Cl. H04N 5/76

(52) U.S. Cl. 348/231.99; 348/333.11

(57) ABSTRACT

A method of and an apparatus for taking an image of a mobile terminal. A shooting direction of the mobile terminal is recognized. When the recognized shooting direction is not a reference direction and an image is taken, a direction of an image stored in a storage unit is matched with a direction of a preview image. Therefore, since an image displayed on a preview screen, desired by a user, is stored, additional editing of the image is not required and user convenience is improved.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Dec. 1, 2009 and assigned Serial No. 10-2009-0117591, the entire disclosure of which is hereby incorporated by reference.

### TECHNICAL FIELD OF THE INVENTION

The present invention relates generally to an apparatus for and a method of taking an image, and more particularly, to a method of and an apparatus for matching a preview image displayed on a preview screen with a image stored in a storage unit of a mobile terminal.

### BACKGROUND OF THE INVENTION

With the rapid technical development, mobile terminals provide basic voice call and various supplementary functions such as a text message transmission and reception function, a function of taking an image, a music function, a digital broadcasting function, an e-mail service function, and an instant messenger service function.

When the function of taking an image is activated, a mobile terminal outputs image data input from a camera sensor on a display unit. A user identifies a subject from the image output on the display unit and takes an image. A user may rotate the mobile terminal to take a portrait image or a landscape image. Moreover, the user may shoot by directing a camera lens to him/her or vice versa.

However, when photographing by rotating the mobile terminal, that is, when photographing by rotating a camera, the preview image is not matched to an actually stored image in the existing method of taking an image. For example, in the existing method of taking an image, a landscape image, an up-down reversed image, or a right-left reversed image may be stored even when a user takes a portrait image. In order to display the same image as the image taken by the user, the user inconveniently rotates his/her mobile terminal or edits to rotate the stored image or converts the stored image up and down or right and left, such that the image is displayed normal.

### SUMMARY OF THE INVENTION

To address the above-discussed deficiencies of the prior art, it is a primary object to provide a method of and an apparatus for taking an image such that a preview image displayed on a preview screen is matched with a stored image stored in a storage unit, performed and installed in a mobile terminal.

In accordance with the aspects of the present invention, there is provided a method of taking an image of a mobile terminal. The method includes outputting a preview image for taking an image when a camera mode is activated. The method also includes recognizing a shooting direction of the mobile terminal. The method further includes controlling a stored image to be matched with the preview image when the recognized shooting direction is different from a preset reference shooting direction.

The present invention also provides an apparatus for taking an image of a mobile terminal including at least one display. The apparatus includes a sensor unit configured to recognize a shooting direction of the mobile terminal. The apparatus also includes a camera module configured to take an image. The apparatus further includes an image signal processor configured to encode image data output from the camera module. The apparatus also includes a control unit configured to control a stored image to be stored the same as a preview image when the shooting direction recognized by the sensor unit is different from a preset shooting direction.

The present invention also provides a mobile terminal configured for taking an image. The mobile terminal includes at least one display and an imaging apparatus coupled to the at least one display. The imaging apparatus includes a sensor unit configured to recognize a shooting direction of the mobile terminal. The imaging apparatus also includes a camera module configured to take an image. The imaging apparatus further includes an image signal processor configured to encode image data output from the camera module. The imaging apparatus further includes a control unit configured to control a stored image to be stored the same as a preview image when the shooting direction recognized by the sensor unit is different from a preset shooting direction.

According to the method of and the apparatus for taking an image of the present invention, the same image as an image output on a preview screen (that is, an image that a user desires) may be stored such that image editing is not required and user convenience may be improved.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates a configuration of a mobile terminal according to an embodiment of the present invention;

FIGS. 2A to 2C illustrate various types of preview images and stored images used in an embodiment of the present invention;

FIG. 3 illustrates a method of taking an image of a mobile terminal according to an embodiment of the present invention; and

FIG. 4 illustrates a method of taking an image of a mobile terminal according to another embodiment of the present invention.

### DETAILED DESCRIPTION OF THE INVENTION

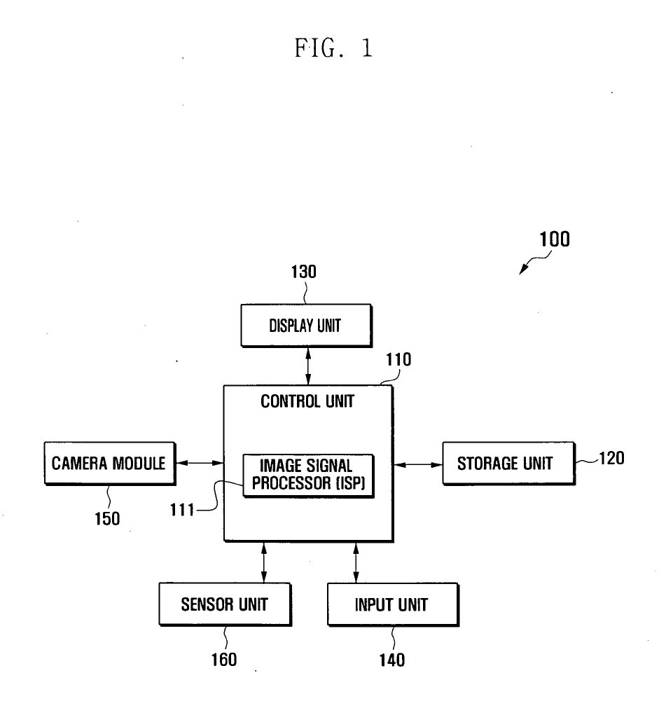

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal.

Embodiments of the present invention will be described in this disclosure and drawings for easy explaining and understanding the technical teaching of the present invention, but do not limit the present invention. It should be understood that many variations and modifications of the basic inventive concept herein described, which may appear to those skilled in the art, will still fall within the spirit and scope of the present invention.

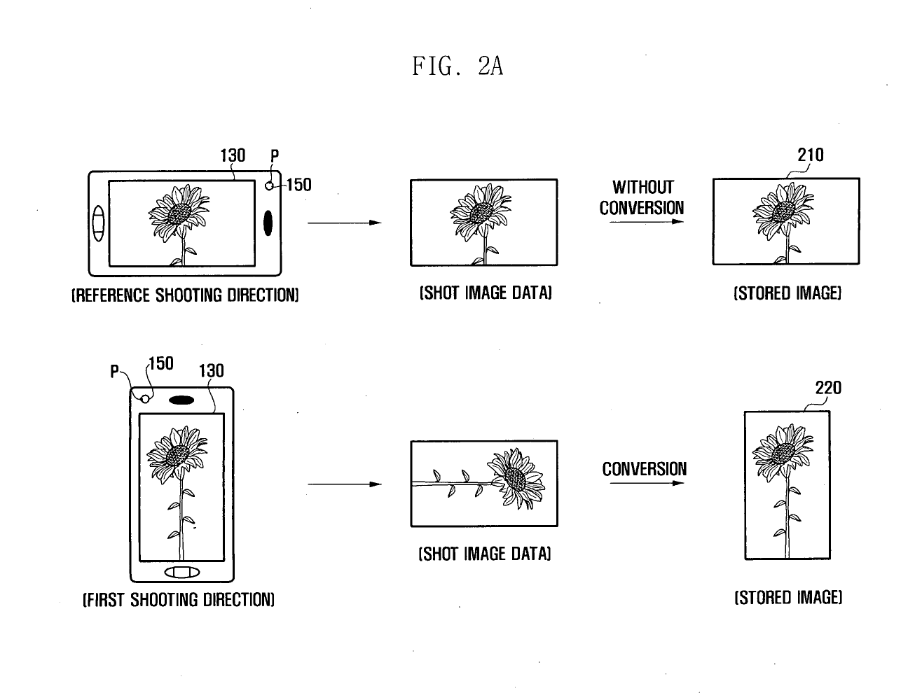

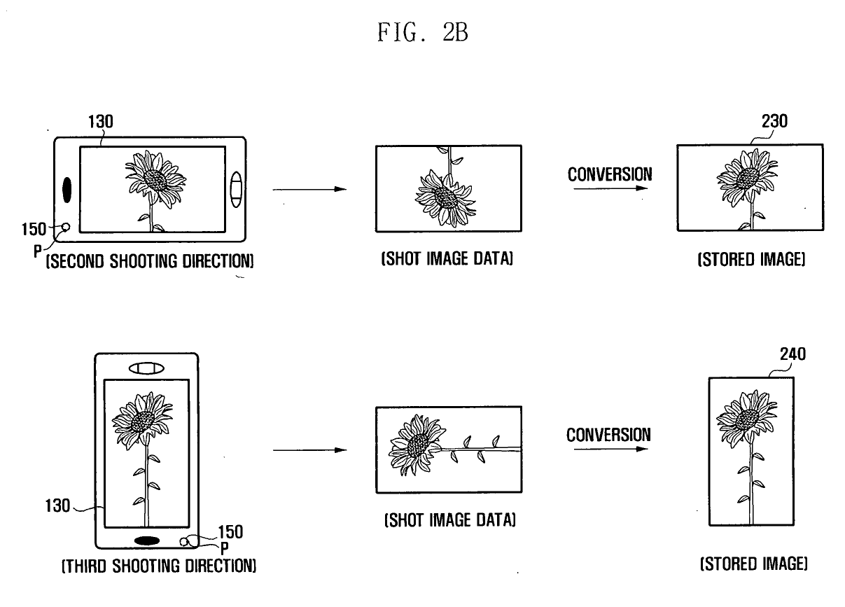

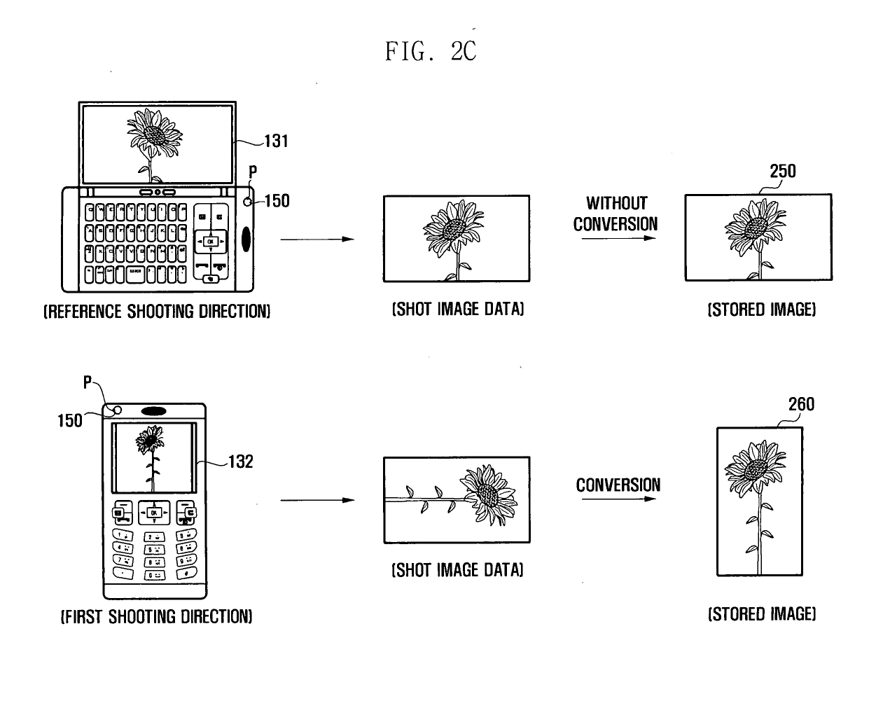

FIG. 1 is a block diagram schematically illustrating a configuration of a mobile terminal 100 according to an embodiment of the present invention. FIGS. 2A to 2C are views illustrating preview images and stored images in directions of the mobile terminal 100 according to an embodiment of the present invention.

Referring to FIG. 1, the mobile terminal 100 according to an embodiment of the present invention may include control unit 110, a storage unit 120, a display unit 130, an input unit 140, a camera module 150, and a sensor unit 160. The control unit 110 may include an image signal processor 111.

The sensor unit 160 is a device that recognizes a shooting direction of the mobile terminal 100. The sensor unit 160 may be activated in a camera mode and may transmit a signal indicating a shooting direction of the mobile terminal 100 to the control unit 110. The sensor unit 160 may be inactivated when the camera mode is finished. The shooting direction of the mobile terminal 100 means a direction of a reference point P preset in the camera module 150 as the display unit 130 rotates from a landscape type to a portrait type. For example, the shooting directions of the mobile terminal 100 may be distinguished by a reference direction where the preset reference point P of the camera module 150 is positioned at the upper side, a first shooting direction where the reference point P is positioned left when the mobile terminal 100 rotates left by 90 degrees, a second shooting direction where the reference point P is positioned at the lower side when the mobile terminal 100 rotates left by 180 degrees, and a third shooting direction where the reference point P is positioned right when the mobile terminal 100 rotates left by 270 degrees.

The sensor unit 160 may include a position sensor such as a three axis position sensor or a six axis position sensor, a geomagnetic sensor, a gravity sensor, or a motion sensor. When the mobile terminal 100 includes a plurality of display units and the shooting direction (a position of the reference point) is changed as a folder is open and closed, the sensor unit 160 may include a hall sensor or a magnetic sensor for checking whether the folder is open. The change of the shooting direction as the folder is open will be described later with reference to the control unit 110. The sensor unit 160 may include a combination of some of the above-mentioned sensors such as a position sensor, a geomagnetic sensor, a gravity sensor, a motion sensor, a hall sensor, and a magnetic sensor.

The camera module 150 is a device for taking an image of a subject and may be mounted at a side of the mobile terminal 100. The camera module 150 may include a camera sensor for converting an optical signal into an electric signal, an image signal processor (hereinafter, referred to as ‘ISP’) for converting an analog video signal into a digital video signal, and a digital signal processor (hereinafter, referred to as ‘DSP’) for processing (scaling, removing noise, converting RGB signals) a video signal output from the ISP. The camera sensor may be a charge coupled device (CCD) or a complementary metal-oxide semiconductor. The ISP and the DSP may be implemented into a single chip. The ISP and the DSP may be not included in the camera module 150 but may be separate devices. Hereinafter, in disclosed embodiments of the present invention, it is assumed that the ISP and the DSP, implemented into a single chip, are included in the control unit 110, and are named an ISP.

The input unit 140 may include input, keys and function keys for receiving numerals and various types of character information, setting various functions and controlling functions of the mobile terminal 100. For example, the input unit 140 may include a call key for requesting a voice call, a video call key for requesting a video call, a volume key for adjusting output volume of an audio signal, a function key for activating a camera mode, and a function key for inputting a shooting signal. The input unit 140 may be configured by a touch pad, a touch screen, a button key pad of common key arrangement, a Qwerty button key pad or any combination of these.

The display unit 130 may display various menu screens of the mobile terminal 100, user data input by the user, function setting information, and various types of information provided to the user. For example, the display unit 130 may output a booting screen, a standby screen, a menu screen, and a video call screen. The display unit 130 may output a preview screen when the camera mode is activated. The preview screen outputs image data input from the camera module 150. The user may identify a subject through the preview screen and may take an image using a function key for inputting a shooting signal. The display unit 130 may display images that are taken and stored.

Although FIGS. 1 to 2B depict a single display unit 130, the present invention is not limited thereto. The display unit 130 may be plural according to the mobile terminal 100. For example, as illustrated in FIG. 2C, the display unit 130 may include two displays 131 and 132, that is, a main display 131 and an auxiliary display 132. The shooting direction may be changed according to whether the main display 131 or the auxiliary display 132 is activated. The display unit 130 may be implemented by a liquid crystal display (LCD), an organic light emitting diode (OLED), and an active matrix organic light emitting diode (AMOLED). When the display unit 130 is implemented in the form of a touch screen, the display unit 130 may serve as the input unit 140.

The storage unit 120 may store an operating system of the mobile terminal 100, optional functions such as applications for a sound reproducing function, an image or moving picture reproducing function, user data, and data transmitted and received during the communication. In an embodiment, the storage unit 120 may store a program for calculating conversion information (for example, a rotation direction and a rotating angle) for storing the same image as the preview image from a signal input from the sensor unit 160. The storage unit 120 may include an encoding program for converting and encoding image data output from the camera module 150 based on the conversion information according to the shooting direction. To this end, the storage unit 120 may store a signal for distinguishing every shooting direction of the mobile terminal 100. The signal for distinguishing the shooting direction may have a preset range. For example, the conversion information may indicate to rotate a shot image left by 90 degrees when the image is taken in a first direction rotated left by 90 degrees from a reference direction. When the mobile terminal 100 include plural displays, the storage unit 120 may store conversion information mapped to the respective displays.

The storage unit 120 may store a shot image. In one embodiment, the storage unit 120 may temporally store the shot image and may semi-permanently store the shot image according to user's choice. To this end, the storage unit 120 may include a buffer or a volatile memory such as random access memory (RAM) temporally storing data and non-volatile memory such as a flash memory for semi-permanently storing data.

The control unit 110 may control overall operations of the mobile terminal 100 and signal flows between internal processing blocks of the mobile terminal 100, and may include a data processor processing data transmitted and received through a wireless communication unit. In an embodiment, the control unit 110 may include an image signal processor ISP 111. The ISP 111 may include a function for converting an analog video signal into a digital video signal, a digital signal processing function for performing an image process (scaling, noise removal, RGB signal conversion) of the digital video signal, and a function for encoding the digital signal processed video signal.

The control unit 110, when the camera mode is activated, outputs a preview screen on the display unit 130 and activates the sensor unit 160 to sense the shooting direction of the mobile terminal 100. When the shooting direction of the mobile terminal 100 is different from the preset reference shooting direction, the control unit 110 may control the stored image stored in the storage unit 120 to be matched with a preview image output on the preview screen. To this end, the control unit 110 may calculate a rotation direction and a rotated angle of the mobile terminal with respect to the reference direction and transmit the calculated results to the ISP 111. The ISP 111 of the control unit 110 may convert and encode the image data output from the camera module 150 using the received rotation direction and rotated angle.

Referring to FIGS. 2A and 2B, as indicated by reference numeral 210 of FIG. 2A, a reference shooting direction of the mobile terminal 100 may be set as the display unit 130 is landscape and the camera module 150 is positioned right. A reference point P of the camera module 150 is positioned at the upper side. As indicated by reference numeral 210 of FIG. 2A, when an image is shot in the reference shooting direction by the camera module 150, the control unit 110 has image data (hereinafter, referred to as shooting image data) output from the camera module 150 identical to the preview image displayed on the preview screen. Thus, the control unit 110 may control the ISP 111 to encode the shooting image data without conversion.

When the mobile terminal 100 is rotated left by 90 degrees and an image is shot in the first direction as indicated by reference numeral 220 of FIG. 2A, the shooting image data output from the camera module 150 is an image in which a preview image is rotated right by 90 degrees. Thus, the control unit 110 may control the ISP 111 to rotate the shooting image data left by 90 degrees and to encode the same. Accordingly, the reference point P of the camera module 150 is positioned left.

As indicated by reference numeral 230 of FIG. 2B, when an image is shot in the second direction where the mobile terminal 100 is rotated left by 180 degrees, the shooting image data is output in the form of which a preview image is rotated right by 180 degrees. Thus, the control unit 110 may control the ISP 111 to rotate the shooting image data left by 180 degrees and to encode the same. Accordingly, the reference point P of the camera module 150 is positioned down.

As indicated by reference numeral 240 of FIG. 2B, when an image is shot in the third direction where the mobile terminal 100 is rotated left by 270 degrees, the shooting image data is output in the form of which a preview image is rotated right by 270 degrees. Thus, the control unit 110 may control the ISP 111 to rotate the shooting image data left by 270 degrees and to encode the same. Accordingly, the reference point P of the camera module 150 is positioned right.

As illustrated in FIG. 2C, when the mobile terminal 100 includes a plurality of displays 131 and 132, the control unit 110 may determine whether an image conversion is performed according to activation of the main display 131. The activation of the main display 131 may be controlled based on an output signal from a hall sensor or a magnetic sensor that checks whether a folder is open. For example, as indicated by reference numeral 250 of FIG. 2C, when the folder is open, that is, when the main display 131 is activated, the control unit 110 may determine the reference direction and control the ISP 111 to encode the shooting image data without conversion. Conversely, as indicated by reference numeral 260 of FIG. 2C, when the main display 131 is closed, that is, when an image is shot using the auxiliary display 132, the control unit 110 may determine the first shooting direction and control the ISP 111 to convert and encode the shooting image data.

As described above, before encoding and storing the image data output from the camera module 150, the image data is converted into the same as the preview image based on the shooting direction of the mobile terminal 100 and stored after encoding thereof.

The ISP 111 of the control unit 110 performs the image conversion, but the present invention is not limited thereto. For example, when the camera module 150 converts the image data to output, the control unit 110 may transmit the calculated rotating direction and the rotated angle to the camera module 150 and the camera module 150 may convert the image data to output based on the received rotating direction and rotated angle. Thus, the ISP 111 performs the encoding without the conversion of the image data. When a mobile terminal 100 according to another embodiment of the present invention includes a driving unit (not shown) for rotating the camera module 150, the control unit 110 may transmit the calculated rotating direction and rotated angle to the driving unit. The driving unit may rotate the camera module 150 as much as the rotated angle in the opposite direction of the calculated rotating direction. By doing so, in the present invention, the preview image may be controlled to be matched with the stored image.

Moreover, although not illustrated, the mobile terminal 100 may further include supplementary elements such as a shot range wireless communication module for short-range wireless communications, a broadcasting module for receiving broadcasting, a digital sound reproducing module such as an MP3 module, and an internet communication module. Not all possible supplementary elements are listed because the list changes to match the convergence trends of digital devices, but the mobile terminal 100 of the present invention may further include supplementary elements similar or equivalent to the above-mentioned supplementary elements.

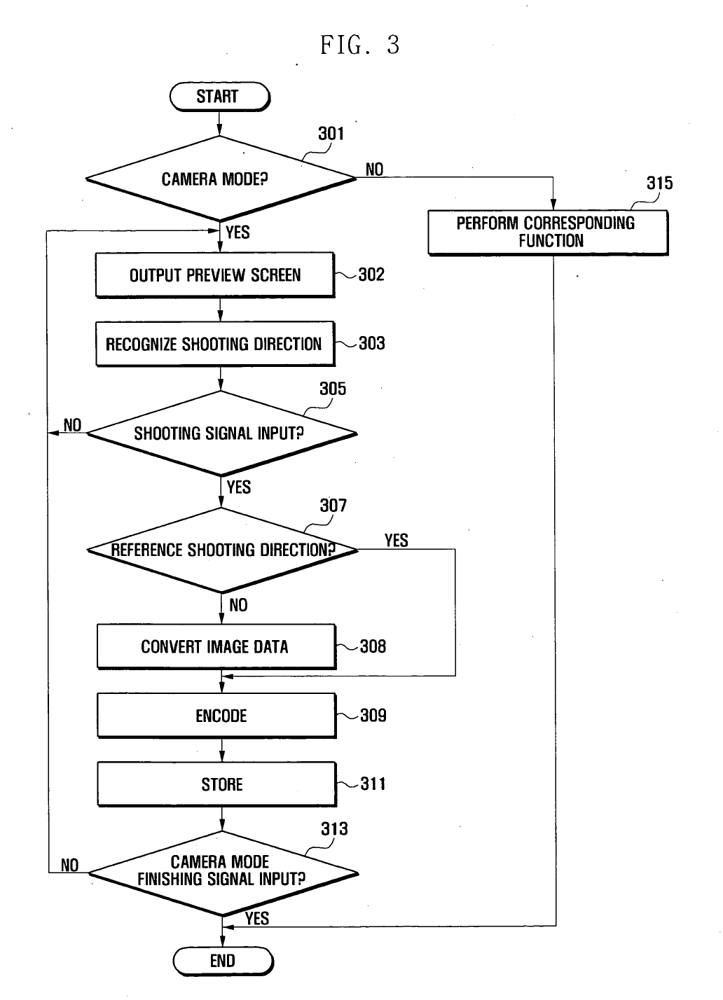

FIG. 3 is a flowchart illustrating a method of taking an image of the mobile terminal 100 according to an embodiment of the present invention.

Referring to FIG. 3, the control unit 110 may check whether the camera mode is activated (block 301). The camera mode may be activated by a preset function key or by a menu of the mobile terminal 100. When the camera mode is inactivated, the control unit 110 may perform a corresponding function (block 315). For example, the control unit 110 may perform a music file reproducing function, a call function, or a broadcasting reproducing function, or may maintain a standby state according to a request from the user.

When the camera mode is activated, the control unit 110 outputs the preview screen on the display unit 130 (block 302) and may recognize the shooting direction of the mobile terminal 100 (block 303). To this end, the control unit 110 may activate the sensor unit 160 and may compare the signal input from the sensor unit 160 with sensing data stored in the storage unit 120 corresponding to the respective shooting directions to recognize the shooting direction of the mobile terminal 100. The sensing data stored in the storage unit 120 may have a preset range.

The shooting direction of the mobile terminal 100 indicates a direction where the preset reference point P of the camera module 150 is positioned when the display unit 130 of the mobile terminal 100 rotates from a landscape type to a portrait type. For example, as described above with reference to FIGS. 2A to 2C, the shooting direction of the mobile terminal 100 may be changed every 90 degrees based on the preset reference shooting direction.

Next, the control unit 110 may check whether a shooting signal associated with a request for taking a subject is input by a preset function key of the input unit 140 (block 305). Otherwise, when the display unit 130 is implemented by a touch screen, the shooting signal may be input by touching the preview screen. When the shooting signal is not input, the control unit 110 returns back (block 302). When the shooting signal is input, the control unit 110 may check whether the shooting direction of the mobile terminal 100 is the reference shooting direction (block 307). When the shooting direction of the mobile terminal 100 is the reference shooting direction (block 307), the control unit 110 encodes the image data (block 309). Conversely, when the shooting direction of the mobile terminal 100 is not the reference shooting direction, the control unit 110 may convert the image data input from the camera module 150 such that the preview image is identical to the stored image. For example, the control unit 110 may control the ISP 111 to rotate the image data input from the camera module 150 or convert the image data up to down or right to left. To this end, the control unit 110 may calculate a current rotating direction and a current rotated angle of the mobile terminal 100 with respect to the reference shooting direction.

Next, the control unit 110 may control the ISP 111 to encode the converted image data (block 309) and may store the encoded image data in the storage unit 120 (block 311). Although not illustrated in FIG. 3, before the block 311, that is, before storing the encoded image data, the encoded image data is output on the display unit 130 and whether the encoded image is stored is checked.

Next, the control unit 110 may check whether a camera mode finishing signal is input (block 313). When the camera mode finishing signal is input, the control unit 110 may finish the camera mode and may return back to the block 302 to repeat the above-mentioned blocks when the camera mode finishing signal is not input.

Although the ISP 111 of the control unit 110 has been described to convert and encode the image data with reference to FIG. 3, the present invention is not limited thereto. For example, when the camera module 150 converts the image data to output, the control unit 110 may transmit information on the calculated rotating direction and rotated angle to the camera module 150 and the camera module 150 may output the converted image data. Otherwise, when the mobile terminal 100 includes the driving unit (not shown) rotating the camera module 150, the control unit 110 may control the driving unit to rotate the camera module 150 based on the rotating direction and the rotated angle. For example, when the camera module 150 is rotated by the driving unit, the image shooting method of the present invention may omit the image data conversion and may further include transmitting a control signal associated with rotating the camera module 150 to the driving unit based on the rotating direction and the rotated angle. The driving unit may include a motor.

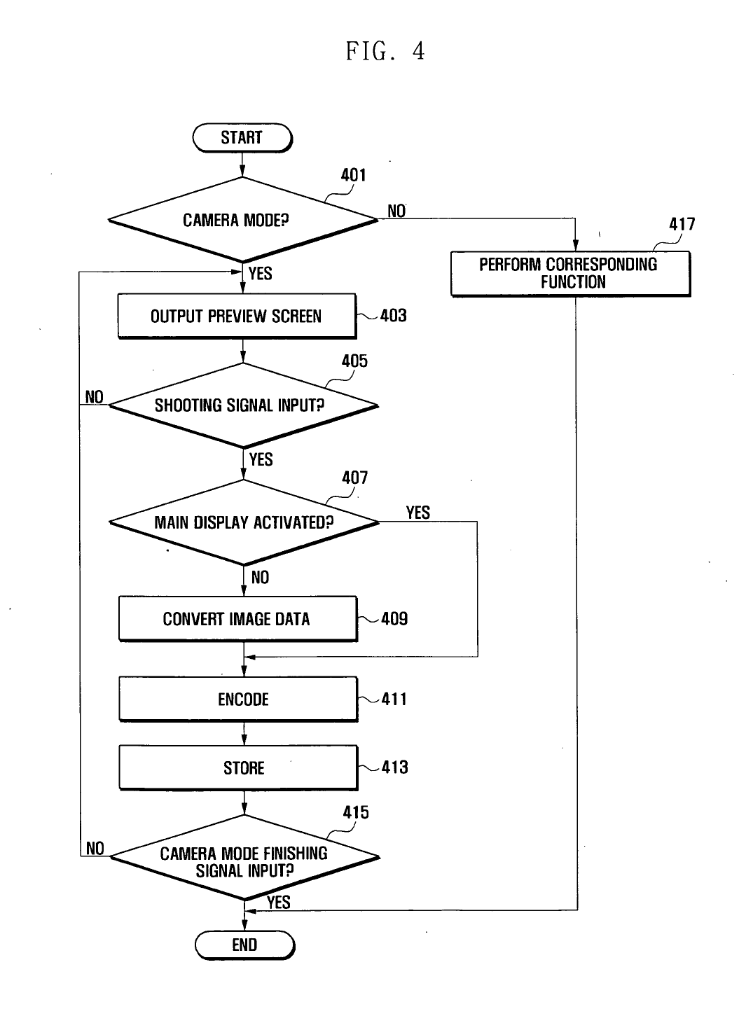

FIG. 4 is a flowchart illustrating a method of taking an image of a mobile terminal 100 according to another embodiment of the present invention.

Hereinafter, the method of taking an image will be described by considering an embodiment where the mobile terminal 100 includes two displays, that is, a main display 131 and an auxiliary display 132.

Referring to FIG. 4, the control unit 110 may check whether the camera mode is activated (block 401). When the camera mode is inactivated, the control unit 110 may perform a corresponding function (block 417). For example, the control unit 110 may perform a music file reproducing function, a call function, or a broadcasting reproducing function, or may maintain a standby state according to a request from the user. When the camera mode is activated, the control unit 110 outputs the preview screen (block 403). The preview screen may be output on the main display 131 or on the auxiliary display 132.

Next, the control unit 110 may check whether a shooting signal associated with a request for taking a subject is input by a preset function key of the input unit 140 (block 405). Otherwise, when the main display 131 or the auxiliary display 132 on which the preview screen is output is implemented by a touch screen, a user may input the shooting signal by touching the preview screen. When the shooting signal is not input, the control unit 110 returns back to check whether the main display 131 is activated (block 407). When the main display 131 is activated, the control unit 110 may perform the block 411, as described below. When the main display 131 is inactivated, that is, when the auxiliary display 132 is activated, the control unit 110 may control the ISP 111 to perform the image data conversion (block 409). To this end, the control unit 110 may control the ISP 111 to search for the conversion information such as the rotating direction and the rotated angle which are mapped to the auxiliary display 132 and stored in the storage unit 120 and to convert the image data output from the camera module 150 in response to the conversion information.

Next, the ISP 111 of the control unit 110 may encode the converted image data (block 411). The control unit 110 may store the encoded image data in the storage unit (block 413). Although not illustrated in FIG. 4, before the block 413, that is, before storing the encoded image data, the encoded image data may be output on the main display 131 or the auxiliary display 132 and whether the encoded image data is stored may be checked.

Next, the control unit 110 may check whether the camera mode finishing signal is input (block 415). When the camera mode finishing signal is input, the control unit 110 may complete the camera mode. When the camera mode finishing signal is not input, the control signal 110 may return back to repeat the above-mentioned blocks (block 403).

Although the ISP 111 of the control unit 110 has been described to convert and encode the image data with reference to FIG. 4, the present invention is not limited thereto. For example, when the camera module 150 may convert the image data to output, the control unit 110 may transmit information on the calculated rotating direction and rotated angle to the camera module 150 and the camera module 150 may output the converted image data. Otherwise, when the mobile terminal 100 includes the driving unit for rotating the camera module 150, the control unit 110 may control the driving unit to rotate the camera module 150 based on the rotating direction and the rotated angle. The driving unit may include a motor.

According to the method of and the apparatus for taking an image of the present invention, since a shot image of a subject maybe stored in the form of an image displayed on the preview screen, that is, an image desired by a user, additional editing of the shot image is not required such that user convenience may be improved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of taking an image using a mobile terminal, the method comprising:
outputting a preview image for taking an image when a camera mode is activated;
recognizing a shooting direction of the mobile terminal; and
controlling a stored image to be matched with the preview image when the recognized shooting direction is different from a preset reference shooting direction.

2. The method of claim 1, wherein, in the recognition of the shooting direction, a rotating direction and a rotated angle of the mobile terminal are calculated with respect to the reference shooting direction.

3. The method of claim 2, wherein controlling a stored image to be matched with the preview image comprises:
transmitting the calculated rotating direction and rotated angle to an image signal processor encoding a shot image; and
converting, by the image signal processor, image data transmitted from a camera module based on the rotating direction and the rotated angle to encode the converted image data and to store the encoded image data as the stored image.

4. The method of claim 2, wherein controlling,a stored image to be matched with the preview image comprises:
transmitting the calculated rotating direction and rotated angle to a camera module;
converting, by the camera module, the image data based on the rotating direction and the rotated angle to transmit the converted image data to an image signal processor; and
encoding, by the image signal processor, the transmitted image data to store the encoded image data as the stored image.

5. The method of claim 2, wherein controlling a stored image to be matched with the preview image comprises:
transmitting the calculated rotating direction and rotated angle to a driving unit rotating the camera module;
rotating, by the driving unit, the camera module based on the rotating direction and the rotated angle; and
encoding the image data output from the rotated camera module to store the encoded image data as the stored image.

6. The method of claim 1, wherein, in the recognition of the shooting direction, when the mobile terminal comprises at least two displays, a determination of which display the preview image is displayed on is made.

7. The method of claim 6, wherein controlling a stored image to be matched with the preview image comprises:
searching for stored conversion information corresponding to a display on which the preview image is displayed when the preview image is displayed on a display different from a preset main display; and
converting the image data output from a camera module to store the converted image data as the stored image based on the conversion information.

8. An apparatus for taking an image at a mobile terminal comprising at least one display, the apparatus comprising:
a sensor unit configured to recognize a shooting direction of the mobile terminal;
a camera module configured to take an image;
an image signal processor configured to encode image data output from the camera module; and
a control unit configured to control a stored image to be stored the same as a preview image when the shooting direction recognized by the sensor unit is different from a preset shooting direction.

9. The apparatus of claim 8, wherein the control unit calculates a rotating direction and a rotated angle of the mobile terminal with respect to the reference shooting direction and controls the image signal processor to convert the image data based on the calculated rotating direction and rotated angle to encode the converted image data.

10. The apparatus of claim 8, wherein the control unit calculates the rotating direction and the rotated angle of the mobile terminal with respect to the reference shooting direction and transmits the calculated rotating direction and rotated angle to the camera module, and the camera module converts and outputs the image data based on the rotating direction and the rotated angle transmitted from the control unit.

11. The apparatus of claim 8, wherein the control unit calculates the rotating direction and the rotated angle of the mobile terminal with respect to the reference shooting direction; and
the apparatus further comprises a driving unit configured to rotate the camera module based on the calculated rotating direction and rotated angle.

12. The apparatus of claim 8, wherein the sensor unit comprises at least one of a position sensor, a geomagnetic sensor, a gravity sensor, a motion sensor, a hall sensor, and a magnetic sensor.

13. The apparatus of claim 8, wherein when the display on which the preview image is displayed is different from a preset main display, the control unit converts and stores the image data output from the camera module based on conversion information mapped to the display on which the preview image is displayed and stored in advance.

14. The apparatus of claim 8, the apparatus further comprising an input unit comprising a plurality of input keys.

15. A mobile terminal configured for taking an image, the mobile terminal comprising:
at least one display; and
an imaging apparatus coupled to the at least one display, the imaging apparatus comprising:
a sensor unit configured to recognize a shooting direction of the mobile terminal;
a camera module configured to take an image;
an image signal processor configured to encode image data output from the camera module; and
a control unit configured to control a stored image to be stored the same as a preview image when the shooting direction recognized by the sensor unit is different from a preset shooting direction.

16. The mobile terminal of claim 15, wherein the control unit calculates a rotating direction and a rotated angle of the mobile terminal with respect to the reference shooting direction and controls the image signal, processor to convert the image data based on the calculated rotating direction and rotated angle to encode the converted image data.

17. The mobile terminal of claim 15, wherein the control unit calculates the rotating direction and the rotated angle of the mobile terminal with respect to the reference shooting direction and transmits the calculated rotating direction and rotated angle to the camera module, and the camera module converts and outputs the image data based on the rotating direction and the rotated angle transmitted from the control unit.

18. The mobile terminal of claim 15, wherein the control unit calculates the rotating direction and the rotated angle of the mobile terminal with respect to the reference shooting direction; and
the imaging apparatus further comprises a driving unit configured to rotate the camera module based on the calculated rotating direction and rotated angle.

19. The mobile terminal of claim 15, wherein the sensor unit comprises at least one of a position sensor, a geomagnetic sensor, a gravity sensor, a motion sensor, a hall sensor, and a magnetic sensor.

20. The mobile terminal of claim 15, wherein when the display on which the preview image is displayed is different from a preset main display, the control unit converts and stores the image data output from the camera module based on conversion information mapped to the display on which the preview image is displayed and stored in advance.
